(19) United States
(12) Patent Application Publication
(10) Pub. No.: US 2018/0033550 A1
(43) Pub. Date: Feb. 1, 2018

(54) COIL COMPONENT AND METHOD FOR MANUFACTURING SAME

(71) Applicant: SAMSUNG ELECTRO-MECHANICS CO., LTD., Suwon-si (KR)

(72) Inventors: Seok Il HONG, Suwon-si (KR); Ju Hwan YANG, Suwon-si (KR); Young Seuck YOO, Suwon-si (KR)

(21) Appl. No.: 15/655,402

(22) Filed: Jul. 20, 2017

(30) Foreign Application Priority Data
Jul. 27, 2016 (KR) 10-2016-0095702

(51) Int. Cl. H01F 41/063; H01F 17/00; H01F 41/04; H01F 27/32; H01F 27/29; H01F 41/12

(52) U.S. Cl. CPC H01F 41/063; H01F 27/292; H01F 41/122; H01F 41/043; H01F 27/32; H01F 17/0013; H01F 2017/0093

(57) ABSTRACT

A coil component includes an insulating layer and a coil pattern provided inside the insulating layer. A lower surface and a side surface of the coil pattern form an acute angle, in a longitudinal cross section of the coil pattern. In particular, a side surface of the coil pattern includes a foot part located in a lower portion of the side surface and an upper part located above the foot part in the side surface, and an angle between the lower surface and the upper part of the side surface of the coil pattern is larger than the acute angle between the lower surface and the foot part of the side surface of the coil pattern. A method of manufacturing the coil component is also provided.

### CROSS-REFERENCE TO RELATED APPLICATION

This application claims the benefit of priority to Korean Patent Application No. 10-2016-0095702, filed on Jul. 27, 2016 with the Korean Intellectual Property Office, the entirety of which is incorporated herein by reference.

### BACKGROUND

### 1. Field

The present disclosure relates to a coil component and a method of manufacturing the same.

### 2. Description of Related Art

Noise countermeasures products are commonly used in high-speed digital interfaces of smart devices, such as displays, Universal Serial Buses (USBs), or the like, to remove noise from received signals. Noise countermeasures products may include product for selectively removing common mode noise, such as common mode filters. A common mode filter is a filter allowing a differential mode signal to pass therethrough and a common mode signal to be selectively removed. In operation of the common mode filter, as magnetic fluxes due to differential mode signals are cancelled by each other, inductance does not occur such that differential mode signals pass. However, as magnetic fluxes due to a common mode noise are reinforced, the action of inductance increases such that common mode noise is removed. The common mode noise may occur when impedances fail to be parallel in a wiring system, or the like. In addition, common mode noise is noticeably generated at a high frequency. As a common mode noise is transmitted to ground, or the like, the common mode noise is returned while drawing a large loop. Therefore, various noise disturbances may be caused even in relatively distant electronic equipment.

In order to ensure reliability of the common mode filter, physical reliability of a coil pattern located therein may need to be improved. In general, a coil pattern inside a common mode filter is formed by plating and etching. As undercut occurs in a lower portion of the coil pattern during etching, adhesion of the coil pattern decreases. Thus, a problem may occur in which physical reliability of the coil pattern decreases. For example, FIG. 6 shows a scanning electron microscope (SEM) image of a coil pattern of a coil component according to the related art. As shown, the occurrence of undercut in a lower portion of a coil pattern is confirmed.

### SUMMARY

An aspect of the present disclosure provides a coil component having excellent physical reliability and a method of manufacturing the same.

According to an aspect of the present disclosure, a coil component includes an insulating layer and a coil pattern provided inside the insulating layer. A lower surface and a side surface of the coil pattern form an acute angle, in a longitudinal cross section of the coil pattern.

According to another aspect of the disclosure, a coil component includes a coil conductor disposed in a coil pattern. In a cross-section of the coil conductor, a side surface of the coil conductor includes a foot part located in a lower portion of the side surface and an upper part located above the foot part in the side surface, and an angle between the foot part and the lower surface of the coil conductor is different from an angle between the upper part and the lower surface of the coil conductor.

According to an aspect of the present disclosure, a method of manufacturing a coil component includes stacking a mask layer on at least one surface of a supporting substrate on which a seed layer is disposed, and removing a portion of the mask layer corresponding to a position in which a coil pattern is to be formed, to expose the seed layer. A plating layer is formed by performing plating on a surface of the seed layer exposed by the removing of the portion of the mask layer. The removing the portion of the mask layer includes forming an undercut part at a lower end of a remaining portion of the mask layer remaining after the removing of the portion of the mask layer.

According to another aspect of the disclosure, a method of forming a coil component includes depositing a mask layer on a surface of a supporting substrate. The method further includes removing a coil-patterned portion of the mask layer from the surface of the supporting substrate such that a remaining portion of the mask layer remains on the surface of the supporting substrate. The removing includes removing an undercut part of the remaining portion of the mask layer disposed between the remaining portion of the mask layer and the surface of the supporting substrate. The method further includes forming a coil conductor within the removed coil-patterned portion of the mask layer and the undercut part of the mask layer.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a cross-sectional view of a coil component according to an exemplary embodiment;

FIG. 2 is an enlarged view of a coil pattern of the coil component of FIG. 1;

FIG. 3 is a Scanning Electron Microscope (SEM) image of a coil pattern of a coil component according to an exemplary embodiment;

FIGS. 4 and 5 show sequential steps of processes for manufacturing the coil component of FIGS. 1 and 2; and

FIG. 6 is a Scanning Electron Microscope (SEM) image of a coil pattern of a coil component according to the related art.

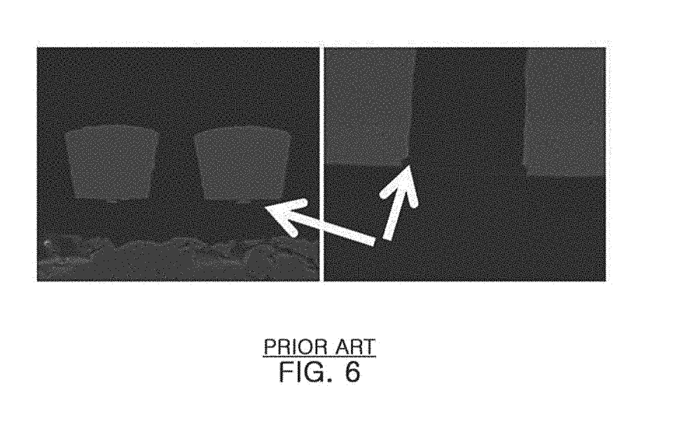

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region, or wafer (substrate), is referred to as being ‘on,’ ‘connected to,’ or ‘coupled to’ another element, it can be directly ‘on,’ ‘connected to,’ or ‘coupled to’ the other element or other elements intervening therebetween may be present. In contrast, when an element is referred to as being ‘directly on,’ ‘directly connected to,’ or ‘directly coupled to’ another element, there may be no other elements or layers intervening therebetween. Like numerals refer to like elements throughout. As used herein, the term ‘and/or’ includes any and all combinations of one or more of the associated listed items.

It will be apparent that although the terms first, second, third, etc. may be used herein to describe various members, components, regions, layers, and/or sections, any such members, components, regions, layers, and/or sections should not be limited by these terms. These terms are only used to distinguish one member, component, region, layer, or section from another member, component, region, layer, or section. Thus, a first member, component, region, layer, or section discussed below could be termed a second member, component, region, layer, or section without departing from the teachings of the exemplary embodiments.

Spatially relative terms, such as ‘above,’ ‘upper,’ ‘below,’ and ‘lower’ and the like, may be used herein for ease of description to describe one element's positional relationship relative to other element(s) in the illustrative orientation shown in the figures. It will be understood that spatially relative terms are intended to encompass different orientations of the device in use or operation, in addition to the orientation depicted in the figures. As such, if the device in the figures is turned over, for example, elements described as ‘above’ or ‘upper’ relative to other elements would then be oriented ‘below’ or ‘lower’ relative to the other elements or features. Thus, the term ‘above’ can encompass both the above and below orientations depending on a particular direction of the figures or devices. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms ‘a,’ ‘an,’ and ‘the’ are intended to include the plural forms as well, unless the context clearly indicates otherwise. It will be further understood that the terms ‘comprises’ and/or ‘comprising,’ when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views shown in the drawings and illustrating embodiments of the present disclosure. In the drawings, components having ideal shapes are shown. However, variations from these ideal shapes, for example due to variability in manufacturing techniques and/or tolerances, also fall within the scope of the disclosure. Thus, embodiments of the present disclosure should not be construed as being limited to the particular shapes of regions shown herein, but should more generally be understood to include changes in shape may resulting from manufacturing methods and processes. The following embodiments may also be constituted alone, in combination or in partial combination.

The contents of the present disclosure described below may have a variety of configurations and illustrative configurations are shown and described herein. However, the disclosure should not be interpreted as being limited to the particular illustrative configurations shown and described.

Hereinafter, a coil component according to an exemplary embodiment will be described, and a common mode filter will be described by way of example for convenience. However, an exemplary embodiment is not limited thereto. Moreover, contents of an exemplary embodiment may be applied to various other coil components. An example of various other coil components may be an inductor, a general bead, a bead for high frequency applications (e.g., GHz Bead), or the like.

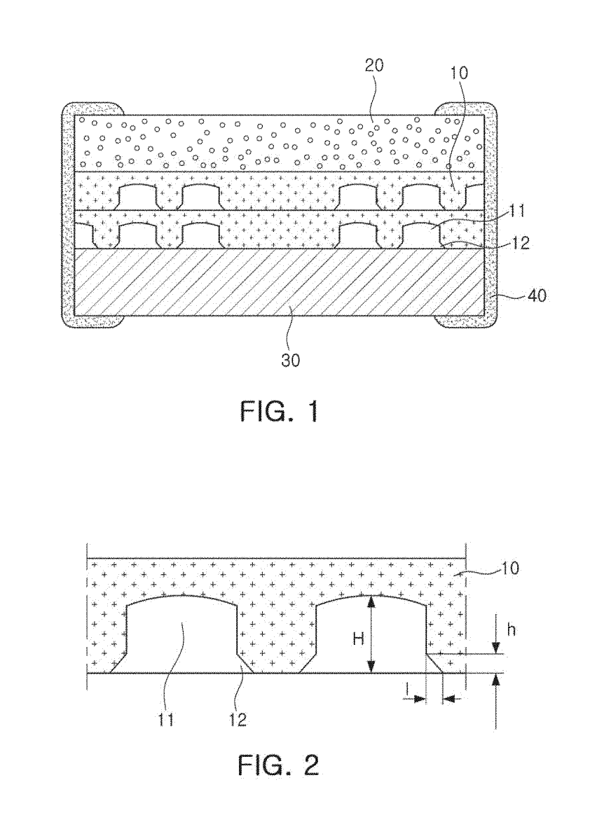

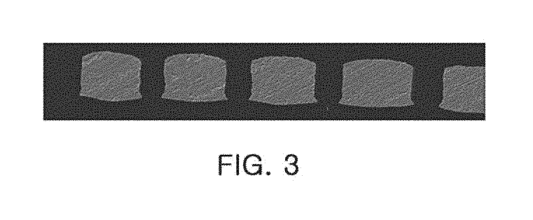

FIG. 1 is a cross-sectional view of a coil component according to an exemplary embodiment, while FIG. 2 is an enlarged view of a coil pattern of the coil component of FIG. 1.

With reference to FIG. 1, a coil component according to an exemplary embodiment may include an insulating layer 10 having a coil pattern 11, a first cover part 20, and a second cover part 30 disposed in an upper portion and a lower portion of the insulating layer, respectively, and an electrode portion 40.

The insulating layer 10 may serve to allow the coil pattern 11 to be insulated from other components of the coil component and to protect the coil pattern. The insulating layer 10 is provided as a plurality of insulating layers to have a stacked structure.

Any of a variety of materials may be used as a material of the insulating layer 10 as long as the material has a property of blocking movement of electrons. For example, a thermosetting resin such as an epoxy resin, a thermoplastic resin such as a polyimide, or a resin in which a reinforcing material, such as an inorganic filler, is impregnated, a polymer with insulating properties, or the like, may be used. For example, an ajinomoto build-up film (ABF), a solder resist (SR), a prepreg (PPG), a photo imageable dielectric (PID), perylene, or the like, available on the market, may be used, but an exemplary embodiment is not limited thereto.

The coil pattern 11 may be formed of a material such as a metal having high electrical conductivity. For example, the coil pattern may be formed of silver (Ag), palladium (Pd), aluminum (Al), nickel (Ni), titanium (Ti), gold (Au), copper (Cu), platinum (Pt), alloys thereof, or the like. In this case, by way of example of a preferred process for manufacturing a flat coil shape, an electroplating method may be used. However, other processes known in the art may be used as long as they have an effect similar to that of the electroplating method.

One end of the coil pattern 11 is exposed to a side surface of the insulating layer 10 to be connected to the electrode portion 40 provided outside of the insulating layer 10.

Although not illustrated in the drawing, the coil pattern 11 may be formed of a primary coil pattern and a secondary coil pattern, electromagnetically coupled to each other. The primary coil pattern and the secondary coil pattern may have a coil structure in which each pattern is alternately arranged on the same plane. Alternatively, the primary coil pattern and the secondary coil pattern are spaced apart by a predetermined interval, respectively disposed in an upper layer and a lower layer while opposing each other, and are electromagnetically coupled to each other. The primary coil pattern and the secondary coil pattern may each be formed of a plurality of layers. In this case, the respective layers of primary coil pattern may be connected to each other by one or more vias, and the respective layers of the secondary coil pattern may be connected to each other by one or more vias. As described above, when currents in the same direction are applied to the primary coil pattern and the secondary coil pattern, because the coil patterns are electromagnetically coupled to each other, magnetic fluxes are reinforced by each other, and common mode impedance is increased to suppress common mode noise. When currents flow in the opposite direction in the primary and secondary coil patterns, magnetic fluxes are canceled by each other, and differential mode impedance decreases to serve as a noise filter allowing only a desired transmission signal to pass therethrough.

The first cover part 20 serves to protect the insulating layer 10. The first cover part 20 may be formed of a magnetic material, and may include, for example, a magnetic resin composite material.

The magnetic resin composite material refers to a composite manufactured by dispersing magnetic particles in a polymer resin. In this case, an epoxy resin may be used for the polymer resin, and ferrite, pure iron, or the like may be used for the magnetic particle. As described above, when the first cover part 20 is formed by including the magnetic material, the first cover part 20 may serve to form a magnetic field with the second cover part 30, to be described later.

The second cover part 30 serves to support and protect the insulating layer 10. The second cover part 30 may be a substrate formed of an insulating material or a magnetic material. When the second cover part 30 is formed of the magnetic material, the second cover part may serve with the first cover part as a closed magnetic path.

The second cover part 30 may be formed of, for example, a Ni-based ferrite material including Fe₂O₃ and NiO as a main component, a Ni—Zn-based ferrite material including Fe₂O₃, NiO, and ZnO as a main component, a Ni—Zn—Cu-based ferrite material including Fe₂O₃, NiO, ZnO, and CuO as a main component, or the like. In this regard, materials described above may be sintered at high temperature to enhance mechanical strength. In addition, the second cover part 30 maybe formed of a non-magnetic material, for example, alumina, silica, or titanium oxide, instead of a ferrite material.

The electrode portion 40 is formed outside of the insulating layer 10. When a coil component is mounted on a circuit board, or the like, the electrode portion may serve to allow the coil component to be electrically connected to the circuit board, or the like.

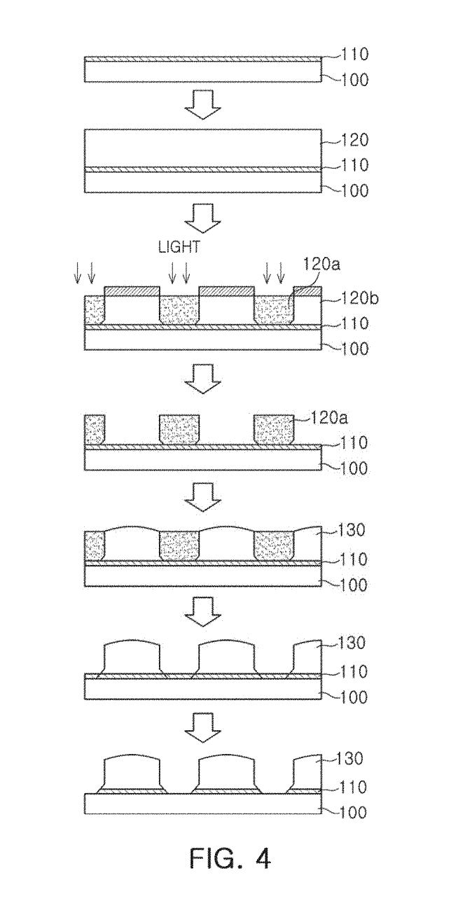

FIG. 2 is an enlarged view of a coil pattern of the coil component of FIG. 1, and FIG. 3 is a Scanning Electron Microscope (SEM) image of a coil pattern of a coil component according to an exemplary embodiment.

With reference to FIGS. 2 and 3, in a coil component according to an exemplary embodiment, in a longitudinal cross section of a coil pattern, a lower surface and a side surface of the coil pattern form an acute angle.

As described previously, in general, a coil pattern inside a common mode filter is formed by plating and etching. When etching, undercut commonly occurs in a lower portion of the coil pattern, so adhesion of the coil pattern decreases. Thus, a problem may occur in which physical reliability of the coil pattern decreases.

Thus, in an exemplary embodiment such as those shown in FIGS. 1-3, a lower surface and a side surface of the coil pattern 11 form an acute angle in order to improve adhesion of the coil pattern and to improve physical reliability.

According to an exemplary example without limitation, as a means to achieve this, a foot part 12 in which a width of the coil pattern increases continuously may be formed at a lower end of a coil pattern.

According to an exemplary example, a height h of the foot part 12 may be approximately 20% of a maximum height H of the coil pattern 11. In general, the height h of the foot part 12 is equal to or less than 20% of a maximum height H of the coil pattern 11.

When the height h of the foot part 12 exceeds 20% of the maximum height H of the coil pattern 11, a distance between coil patterns adjacent to each other may be significantly narrowed such that short circuits may disadvantageously occur. Here, a height of the foot part 12 refers to a distance from a lower surface of a coil pattern to a position at which a continuous decrease in a width of the coil pattern is first stopped.

According to an exemplary example, a maximum protruding length l of the foot part 12 may be 1 μm to 10 μm. The maximum protruding length l of the foot part 12 may correspond to the maximum lateral distance by which the foot part 12 extends from the vertical side surface of the coil pattern. When the maximum protruding length l is outside of a range described above, an effect of improving physical reliability is not significant, or a distance between coil patterns adjacent to each other is significantly narrowed such that short circuits may occur.

According to an exemplary example, both side surfaces of the coil pattern 11 (in areas other than the area in which the foot part 12 is formed) may have a parallel structure. Here, ‘parallel’ means not only a case of being physically completely parallel, but also a case of being substantially parallel. In a manner different therefrom, when a width of a coil pattern increases continuously from an upper surface of the coil pattern to a lower surface thereof, for example, when a coil pattern has a trapezoidal cross-section, a cross-sectional area of the coil pattern is reduced because of the narrowing of the coil pattern in upper portions thereof, so direct current resistance (Rdc) characteristics may be degraded.

According to an exemplary example, an upper end of the coil pattern 11 may be formed to be convex upwardly. As described above, when the upper end of the coil pattern 11 is formed to be convex upwardly, a cross-sectional area of the coil pattern becomes relatively large, so direct current resistance (Rdc) characteristics may be further improved.

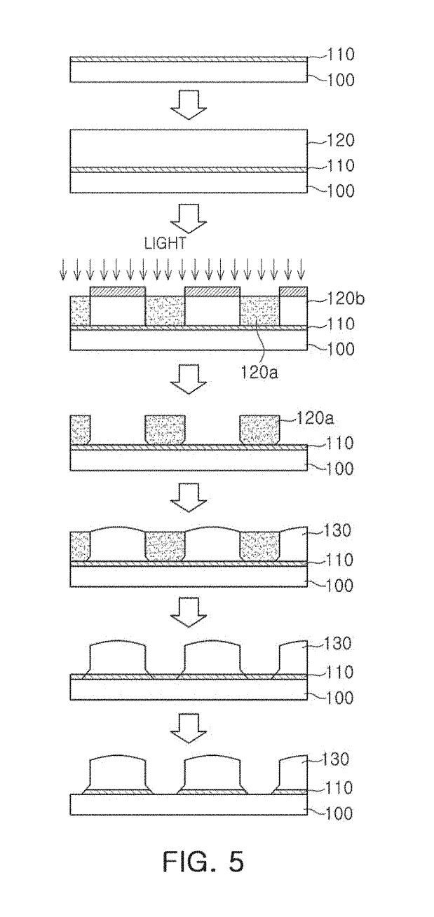

FIGS. 4 and 5 show sequential steps of processes for manufacturing the coil component of FIGS. 1 and 2. Hereinafter, descriptions overlapped with descriptions provided above are omitted, and each operation or step of an illustrative process of manufacturing a coil component will be described.

First, a supporting substrate 100 on a surface of which a seed layer 110 is formed is prepared. As long as proper stiffness is provided by the supporting substrate 100 to the insulating layer 10 and the coil pattern 11 during a process of manufacturing a coil component, a specific type of the supporting member or substrate 100 is not particularly limited. For example, the supporting member or substrate 100 may be a silicon wafer (Si wafer). Meanwhile, the seed layer 110, a metal layer including the same type of metal as a metal included in a plating layer 130 which will be described later, helps formation of a coil pattern by plating. The seed layer 110 may be formed by applying a sputtering method, a spin process, a chemical copper method, or the like, but an exemplary example is not limited thereto.

Next, a mask layer 120 is stacked on at least one surface of the supporting substrate 100 on which the seed layer 110 is formed.

Any material may be applied as the mask layer 120 as long as the material is a photosensitive polymer in which peeling is possible after formation of a pattern, and reaction occurs selectively by light. For example, the mask layer 120 may be a Dry Film Resist (DFR) film or a Negative Type Photoresist film. Here, a negative photoresist is a photosensitive polymer in which only a polymer in a portion which light touches (an exposure portion) is insolubilized and only a polymer in the exposure portion remains after development. An example of the negative photoresist may be aromatic bisazide (bis-azide), methacrylic aid ester, cinnamic acid ester, or the like, but an exemplary example is not limited thereto.

Next, a non-exposure area 120b, i.e. a portion of the mask layer 120 corresponding to a position in which the coil pattern 11 is to be formed, is removed. An operation described above may be achieved by covering an upper portion of the mask layer 120 with a photomask having the same shape as that of a coil pattern, and performing exposure and development thereafter.

With reference to FIGS. 4 and 5, an undercut part is formed at a lower end of an exposure area 120a of the mask layer 120. In turn, when a coil pattern is formed using the mask layer in which an undercut part is formed, a foot part is formed in the coil pattern.

Meanwhile, the following two methods are provided as illustrative methods for forming an undercut part at a lower end of the exposure area 120a of the mask layer 120.

First, as illustrated in FIG. 4, an undercut part may be formed by adjusting an exposure amount. In other words, when a sufficient exposure amount is not provided during exposure (e.g., when only an insufficient exposure amount is provided during exposure), a polymer located near a boundary of the mask layer 120 and the seed layer 110 does not receive a sufficient amount of light to allow the polymer to be insolubilized. As a result, the polymer located near the boundary of the mask layer 120 and the seed layer 110 is removed after development and an undercut part is formed.

Alternatively or additionally, as illustrated in FIG. 5, an undercut part may be formed by adjusting a development amount. In other words, although a sufficient exposure amount is provided during exposure and all polymers located near a boundary of the mask layer 120 and the seed layer 110 are insolubilized, when a development amount is excessive (e.g., a development time exceeds a normal development time, and/or an amount of developing agent exceeds a normal amount used), a polymer located near a boundary of the mask layer 120 and the seed layer 110, in which a degree of insolubility is lowest, is removed in addition to being removed in the non-exposure area 120b of a mask layer during development. As a result, an undercut part is formed.

Next, plating is performed on a surface of the seed layer 110 having been exposed externally by removing a portion of the mask layer 120, and the plating layer 130 is thereby formed. The plating layer 130 maybe formed using a method such as an electroless plating method, an electrolytic plating method, or the like, but an exemplary embodiment is not limited thereto.

Next, a mask layer remaining in the exposure area 120a is removed. For removal of the remaining mask layer, a method known such as peeling, etching, or the like may be used, but an exemplary embodiment is not limited thereto.

Next, areas of the seed layer 110 disposed at locations corresponding to the remaining mask layer are removed. The removal can be performed by a method such as etching, or the like, but an exemplary embodiment is not limited thereto.

As set forth above, a coil component according to an exemplary embodiment may have excellent physical reliability.

While exemplary embodiments have been shown and described above, it will be apparent to those skilled in the art that modifications and variations could be made without departing from the scope of the present invention as defined by the appended claims.

What is claimed is:

1. A coil component, comprising:
an insulating layer; and
a coil pattern provided inside the insulating layer,
wherein a lower surface and a side surface of the coil pattern form an acute angle, in a longitudinal cross section of the coil pattern.

2. The coil component of claim 1, wherein each side surface of the coil pattern includes a foot part located in a lower portion of the side surface and an upper part located above the foot part in the side surface, and an angle between the lower surface and the upper part of the side surface of the coil pattern is larger than the acute angle between the lower surface and the foot part of the side surface of the coil pattern.

3. The coil component of claim 2, wherein the upper part of the side surface of the coil pattern is orthogonal to the lower surface of the coil pattern.

4. The coil component of claim 1, wherein a foot part at a lower end of the coil pattern has a width that increases continuously towards the lower surface of the coil pattern.

5. The coil component of claim 4, wherein a height of the foot part having the width that increases continuously is equal to or less than 20% of a maximum height of the coil pattern.

6. The coil component of claim 4, wherein a maximum protruding length of the foot part relative to a side surface of the coil pattern is 1 μm to 10 μm.

7. The coil component of claim 4, wherein opposing side surfaces of the coil pattern are parallel to each other in areas other than the foot part.

8. The coil component of claim 1, wherein an upper end of the coil pattern is convex upwardly.

9. The coil component of claim 1, wherein the coil pattern is formed by plating.

10. The coil component of claim 1, wherein the insulating layer is provided as a plurality of insulating layers forming a stacked structure, and the coil pattern includes a plurality of coil layers each provided inside a respective insulating layer.

11. The coil component of claim 10, further comprising a first cover part and a second cover part disposed on an upper surface and a lower surface of the insulating layer, respectively.

12. The coil component of claim 1, further comprising an electrode formed on an outside of the insulating layer.

13. The coil component of claim 12, wherein one end of the coil pattern is exposed to a side surface of the insulating layer to be connected to the electrode provided on the side surface of the insulating layer.

14. A method of manufacturing a coil component, comprising:
stacking a mask layer on at least one surface of a supporting substrate on which a seed layer is disposed;
removing a portion of the mask layer corresponding to a position in which a coil pattern is to be formed, to expose the seed layer; and
forming a plating layer by performing plating on a surface of the seed layer exposed by the removing of the portion of the mask layer,
wherein the removing the portion of the mask layer includes forming an undercut part at a lower end of a remaining portion of the mask layer remaining after the removing of the portion of the mask layer.

15. The method of manufacturing a coil component of claim 14, further comprising:
removing the remaining portion of the mask layer, after the forming the plating layer; and
removing a portion of the seed layer disposed at a location corresponding to the remaining portion of the mask layer.

16. The method of manufacturing a coil component of claim 14, wherein the mask layer is a Dry Film Resist (DFR) film or a Negative Type Photoresist film.

17. The method of manufacturing a coil component of claim 16, wherein the removing the portion of the mask layer is performed by partial exposure and development with respect to the mask layer, and
a size of the undercut part is increased by increasing an amount of exposure.

18. The method of manufacturing a coil component of claim 16, wherein the removing the portion of the mask layer is performed by partial exposure and development with respect to the mask layer, and
a size of the undercut part is increased by increasing an amount of development.

19. A coil component comprising:
a coil conductor disposed in a coil pattern,
wherein in a cross-section of the coil conductor, a side surface of the coil conductor includes a foot part located in a lower portion of the side surface and an upper part located above the foot part in the side surface, and an angle between the foot part and the lower surface of the coil conductor is different from an angle between the upper part and the lower surface of the coil conductor.

20. The coil component of claim 19, wherein the upper part of the side surface is orthogonal to the lower surface of the coil conductor.

21. The coil component of claim 20, wherein the foot part of the side surface forms an acute angle with the lower surface of the coil conductor.

22. The coil component of claim 19, wherein a width of the coil conductor is substantially constant in the upper part thereof.

23. The coil component of claim 22, wherein a width of the coil conductor increases near the lower surface in the foot part thereof.

24. The coil component of claim 19, wherein an upper surface of the coil conductor is arched.

25. The coil component of claim 19, wherein a height of the foot part is equal to or less than 20% of a thickness of the coil conductor.

26. The coil component of claim 19, wherein the foot part extends laterally outward relative to a plane coincident with the upper part of the side surface by 1 μm to 10 μm.

27. The coil component of claim 19, wherein the coil pattern comprises a plurality of windings, and
wherein in the cross-section of the coil conductor, each side surface of the coil conductor includes a foot part located in a lower portion of the side surface and an upper part located above the foot part in the side surface, and an angle between the foot part and the lower surface of the coil conductor is different from an angle between the upper part and the lower surface of the coil conductor.

28. A method of forming a coil component, comprising:
depositing a mask layer on a surface of a supporting substrate;
removing a coil-patterned portion of the mask layer from the surface of the supporting substrate such that a remaining portion of the mask layer remains on the surface of the supporting substrate, wherein the removing comprises removing an undercut part of the remaining portion of the mask layer disposed between the remaining portion of the mask layer and the surface of the supporting substrate; and
forming a coil conductor within the removed coil-patterned portion of the mask layer and the undercut part of the mask layer.

29. The method of claim 28, wherein the undercut part is disposed adjacent to the coil-patterned portion of the mask layer and between the remaining portion of the mask layer and the surface of the supporting substrate.

30. The method of claim 29, wherein the undercut part extends under the remaining portion of the mask layer by a distance of 1 μm to 10 μm from the coil-patterned portion of the mask layer.

31. The method of claim 29, wherein the undercut part reaches a height of no more than 20% of a height of the formed coil conductor.

32. The method of claim 28, wherein the mask layer is formed of a photosensitive polymer, the removing the coil-patterned portion of the mask layer comprises performing a partial exposure and development with respect to the mask layer, and the method further comprises adjusting an amount of exposure of the partial exposure and development to obtain the undercut part.

33. The method of claim 28, wherein the mask layer is formed of a photosensitive polymer, the removing the coil-patterned portion of the mask layer comprises performing a partial exposure and development with respect to the mask layer, and the method further comprises adjusting an amount of development of the partial exposure and development to obtain the undercut part.
